(19) United States
(12) Patent Application Publication
(10) Pub. No.: US 2022/0348459 A1
(43) Pub. Date: Nov. 3, 2022

(54) REACTOR SYSTEMS AND METHODS FOR THERMALLY DECOMPOSING AMMONIA

(71) Applicant: Regents of the University of Minnesota, Minneapolis, MN (US)

(72) Inventors: William Northrop, Minneapolis, MN (US); Seamus P. Kane, Minneapolis, MN (US)

(21) Appl. No.: 17/728,433

(22) Filed: Apr. 25, 2022

Related U.S. Application Data
(60) Provisional application No. 63/178,827, filed on Apr. 23, 2021.

(51) Int. Cl. C01B 3/04; B01J 8/02

(52) U.S. Cl. CPC C01B 3/047; B01J 8/0285; B01J 2208/00176; B01J 2208/00504; B01J 2208/00548; C01B 2203/0277; B01J 2208/00796

(57) ABSTRACT

This disclosure relates to reactor systems and methods of decomposing ammonia. In some aspects, a catalyst reactor includes an elongated conduit extending along a longitudinal axis. The elongated conduit can include a wall defining an interior cavity, an inlet configured for receiving a first fluid, and an outlet to flow the first fluid out of the elongated conduit, the wall having an interior cross-section defined by a major axis, W, and a minor axis, H, the major axis and the minor axis defining an aspect ratio, α=W/H, wherein the aspect ratio is greater than 2.0; and a catalytic structure disposed within the interior cavity of the elongated conduit.

### CROSS-REFERENCE TO RELATED APPLICATIONS

This application claims the benefit of priority to U.S. Provisional Application Ser. No. 63/178,827, filed on Apr. 23, 2021. The disclosure of the prior application is considered part of and is incorporated by reference in its entirety into the disclosure of the present application.

### TECHNICAL BACKGROUND

This disclosure relates to reactor systems and methods of decomposing ammonia.

### BACKGROUND

A fluid can be decomposed, that is, broken up into its constituent components, by various methods and industrial processes. Some fluids can be decomposed by mechanical processes. Other fluids can be decomposed by chemical processes. Some fluids can be decomposed in conjunction with other industrial processes, such as power generation.

### SUMMARY

The present disclosure relates to reactor systems and methods of decomposing ammonia.

Implementations of the present disclosure include a catalyst reactor including an elongated conduit extending along a longitudinal axis. The elongated conduit can include a wall defining an interior cavity, an inlet configured for receiving a first fluid, and an outlet to flow the first fluid out of the elongated conduit, the wall having an interior cross-section defined by a major axis, W, and a minor axis, H, the major axis and the minor axis defining an aspect ratio,

$$α = \frac{W}{H} ,$$

wherein the aspect ratio is greater than 2.0; and a catalytic structure disposed within the interior cavity of the elongated conduit.

In some embodiments, the catalytic structure has a cross-section shape is the same shape as the interior cross-section of the elongated conduit.

In some embodiments, the catalytic structure comprises a plurality of catalytic structures. In some embodiments, the catalytic structure is a catalytic monolith. In some embodiments, the catalytic structure is fixedly coupled to the elongated conduit. In some embodiments, the catalytic structure is coupled to the elongated conduit by an interference fit. In some embodiments, the catalytic structure comprises a ceramic, a metal, or combinations thereof. In some embodiments, the catalytic structure comprises a metal foam substrate. In some embodiments, the catalytic structure comprises a plurality of catalyst pellets.

In some embodiments, the elongated conduit comprises a u-shaped section. In some embodiments, the catalyst structure is disposed within the elongated conduit and configured to change a composition of the first fluid responsive to a transfer of heat across the wall of the elongated conduit. In some embodiments, the elongated conduit includes a first shell; and a second shell configured to couple to the first shell; wherein the first and second shells couple together to define the elongated conduit.

In some embodiments, the elongated conduit further comprises a stamped portion that recesses the wall in a transverse direction toward a central axis of the conduit wall. In some embodiments, the stamped portion comprises two opposing wall portions that are each recessed in a transverse direction toward a central axis of the conduit and coupled together. In some embodiments, the elongated conduit comprises a plurality of stamped portions. In some embodiments, the stamped portion is at least one of a circular shape, a square shape, or a rectangular shape.

In some aspects, a catalyst reactor system includes a reactor housing defining an enclosure, the housing including a main inlet configured for receiving a heat exchanging fluid and a main outlet for flowing the heat exchanging fluid out of the housing; a catalyst reactor assembly disposed within the enclosure of the reactor housing such that the heat exchanging fluid flows along an exterior of the catalyst reactor assembly. The catalyst reactor assembly includes first and second catalyst reactors. Each catalyst reactor includes an elongated conduit comprising a wall defining an interior cavity and an exterior surface configured for transferring heat from the heat exchanging fluid to the interior cavity, an inlet configured for receiving a first fluid, an outlet configured to flow the first fluid out of the elongated conduit, the elongated conduit having an interior cross-section defined by a major dimension and a minor dimension, the major and minor dimensions defining an aspect ratio,

$$α = \frac{W}{H} ,$$

which has a value greater than 2.0; and a catalytic structure disposed within the interior cavity of the elongated conduit; an inlet conduit fluidically coupled to the inlets of the first and second catalyst reactors; and an outlet conduit fluidically coupled to the outlets of the first and second catalyst reactors.

In some embodiments, the inlet conduit further comprises an inlet flow control device configured to control the flow of the first fluid to the first and second catalyst reactors. In some embodiments, the outlet conduit further comprises an outlet flow control device configured to control the flow of the first fluid from the first and second catalyst reactors. In some embodiments, the first and second catalyst reactors are thermo-chemical recuperators.

In some embodiments, the elongated conduit is angled relative to the heat exchanging fluid to induce a turbulence in the heat exchanging fluid.

In some embodiments, the catalyst reactor system is incorporated in a plant comprising at least one of a power generation plant, a chemical reactor, a nuclear reactor, a biological reactor, and a chemical extraction process. In some embodiments, the catalyst reactor system includes a duct burner disposed in the reactor housing, the duct burner configured to mix a portion of the first fluid with the heat exchanging fluid, and burn the mixture of the portion of the first fluid and the heat exchanging fluid to raise the temperature of the heat exchanging fluid.

In some embodiments, the catalyst reactor assembly is positioned proximal to an output of a reduction catalyst reactor of the power generation plant such that a threshold quantity of heat is transferred from the reduction catalyst reactor to the catalyst reactor assembly. In some embodiments, the catalyst reactor assembly is positioned proximal to an output of an oxidation catalyst reactor of the power generation plant such that a threshold quantity of heat is transferred from the oxidation catalyst reactor to the catalyst reactor assembly.

In some embodiments, the elongated conduit comprises a u-shaped section. In some embodiments, the catalyst structure is disposed within the elongated conduit and configured to change a composition of the first fluid responsive to a transfer of heat from the heat exchanging fluid across the wall of the elongated conduit.

In some embodiments, the catalyst reactor system includes a pre-heating system, a vaporizing system, a combustor, or combinations thereof. In some embodiments, the catalyst reactor system includes a duct burner.

In certain aspects, a method for thermal decomposition includes receiving a first fluid at a first temperature from an inlet conduit at a catalytic reactor assembly. The catalyst reactor assembly can include first and second catalyst reactors. Each catalyst reactor can include an elongated conduit comprising a wall defining an interior cavity and an exterior surface configured for transferring heat from the heat exchanging fluid to the interior cavity, an inlet configured for receiving a first fluid, an outlet configured to flow the first fluid out of the elongated conduit, the elongated conduit having an interior cross-section defined by a major dimension and a minor dimension, the major and minor dimensions defining an aspect ratio,

$$α = \frac{W}{H} ,$$

which has a value greater man 2.0, and a catalytic structure disposed within the interior cavity of the elongated conduit. The catalyst reactor assembly can be positioned within a reactor housing defining an enclosure. The housing can include a main inlet configured for receiving a heat exchanging fluid and a main outlet for flowing the heat exchanging fluid out of the housing. The method can include receiving the heat exchanging fluid at a second temperature at the main inlet of the reactor housing; flowing the heat exchanging fluid at the second temperature from the main inlet of the reactor housing to the first and second catalyst reactors; receiving the heat exchanging fluid at the second temperature at the first and second catalyst reactors; flowing the heat exchanging fluid to at least a portion of the exterior surfaces of the first and second catalyst reactors such that the heat exchanging fluid transfers heat to the first fluid across the walls of the conduits; and heating the first fluid to a third temperature such that the first fluid changes its composition.

In some embodiments, the method can include flowing the heat exchanging fluid to the main outlet; and exhausting the heat exchanging fluid to an atmosphere. In some embodiments, the first fluid comprises an ammonia, heating the first fluid to a third temperature such that the first fluid changes its composition comprises decomposing the ammonia responsive to the transfer of heat from the heat exchanging fluid to the first fluid.

In some embodiments, the method includes flowing the heat exchanging fluid to at least a portion of the exterior surfaces of the first and second catalyst reactors such that the heat exchanging fluid transfers heat to the first fluid across the walls of the conduits comprising inducing turbulence in the heat exchanging fluid as the heat exchanging fluid flows to at least the portion of the exterior surfaces of the first and second catalyst reactors to increases the transfer of heat from the heat exchanging fluid to the first fluid.

Particular implementations of the subject matter described in this specification can be implemented so as to realize one or more of the following advantages.

Implementations of the present disclosure can advantageously reduce exhaust pollution to the environment. For example, with the systems and methods provided herein, ammonia can be used to decompose into hydrogen and nitrogen at concentrations suitable for complete combustion and, thereby, reduce the amount of released nitrogen oxides that pollutes the environment. In some cases, the systems and methods described herein can use ammonia for power generation to reduce carbon emissions to the environment. As will be discussed in the later sections, various implementations of the present disclosure can increase power generation efficiency. In some embodiments, preexisting inefficient systems (e.g., heat recovery steam generators in power generation systems) can be replaced with more efficient systems and assemblies described herein. For example, in some embodiments, the systems provided herein include a selective catalytic reduction catalyst that advantageously reduces nitrogen oxides to increase the exhaust temperature, generate higher temperatures for waste heat for recovery operations, and, ultimately, reduce the waste heat lost to the environment. In some embodiments, the systems and methods provided herein can increase the heat transfer between system components, and, in turn, increase the power generation efficiency.

Various embodiments of the present disclosure provides systems and methods can provide efficient ammonia combustion, reduce NOx passively with unburned NH₃, and/or increase thermal efficiency with a thermochemical recuperation reactor (TCR). In some embodiments, the systems and reactors disclosed herein can provide a simple, efficient design that is easy to manufacture and install in both new and existing structures.

The details of one or more embodiments of the invention are set forth in the accompanying drawings and the description below. Other features, objects, and advantages of the invention will be apparent from the description and drawings, and from the claims. The features described below in separate embodiments can be combined in alternate embodiments.

### DESCRIPTION OF DRAWINGS

FIG. 1 is a schematic view of an exemplary catalyst reactor system incorporated into a simple power generation system.

FIGS. 2A-2C are perspective views of an exemplary catalyst reactor system.

FIG. 3A is a top view an exemplary catalyst reactor assembly.

FIG. 3B is a side view of the catalyst reactor assembly of FIG. 3A.

FIG. 3C is a perspective top view of the catalyst reactor assembly of FIG. 3A.

FIG. 3D is a magnified top view of the catalyst reactor assembly of FIG. 3A.

FIG. 3E is a cross-sectional view of the catalyst reactor assembly of FIG. 3B.

FIG. 3F is a cross-sectional perspective view of the catalyst reactor assembly of FIG. 3B along cross-section A-A.

FIG. 3G is a cross-sectional view of the catalyst reactor assembly of FIG. 3C along cross-section B-B.

FIG. 3H is an exploded cross-sectional perspective view of the catalyst reactor assembly of FIG. 3G.

FIGS. 4A-4C illustrate exemplary surface area geometries for a catalyst structure.

FIG. 5 is a graph of the effect of aspect ratio on thermal transport in designs having catalysts with identical volume and cross-sectional area.

FIG. 6 illustrates an exemplary catalyst reactor system incorporated into a power generation plant.

FIG. 7 illustrates an exemplary catalyst reactor system incorporated into a heat recovery steam generator plant.

FIG. 8 illustrates an exemplary catalyst reactor system incorporated into a heat recovery steam generator plant.

FIG. 9 illustrates an exemplary catalyst reactor system incorporated into a natural gas combined cycle power plant.

FIG. 10 illustrates an exemplary catalyst reactor system incorporated into a natural gas combined heat and power plant.

FIG. 11 illustrates an exemplary catalyst reactor system incorporated into an internal combustion engine.

FIG. 12 illustrates an exemplary catalyst reactor system incorporated into a heat recovery steam generator plant.

FIG. 13 is a flow chart of an exemplary method of thermal decomposition of ammonia using a reactor system according to the present disclosure.

Like reference numbers and designations in the various drawings indicate like elements.

### DETAILED DESCRIPTION

The present disclosure relates to reactor systems and methods of thermally decomposing ammonia. The reactor systems provided herein can include one or more catalyst reactors configured to thermally decompose ammonia for combustion-fueled generating systems. In some embodiments, the reactor systems provided herein can be incorporated into other heat-producing systems, including, but not limited to, a system that includes a chemical reactor, a nuclear reactor, a biological reactor, a reactor configured for a chemical extraction, or combinations thereof.

The systems and catalytic reactors described herein can include a conduit having a structure extending along a longitudinal axis. The catalytic reactor can include one or more catalyst structures within the conduit structure.

The conduit can be elongate. The conduit can have a wall defining an interior cavity, an inlet to receive a fluid (e.g., ammonia), and an outlet to flow a fluid (e.g., decomposed ammonia) out of the conduit. The wall can have an interior cross-section defined by a major axis, W, and a minor axis, H. The major axis and the minor axis defining an aspect ratio (see Equation 1 provided below), wherein the aspect ratio α is greater than 2.0. One or more catalytic structures can be positioned within the interior cavity of the elongated conduit.

$$α = \frac{W}{H} \qquad Equation 1$$

TABLE 1
Effect of varied aspect ratio on the height
and width of a rectangular cross section

| | | | Ratio of |
|---|---|---|---|
| | | | Surface |
| Aspect Ratio | Height | Width | Area:Vol |
| 1.00 | 1.00 | 1.00 | 4.00 |
| 1.5 | 0.98 | 1.02 | 4.00 |
| 1.7 | 0.97 | 1.03 | 4.00 |
| 1.10 | 0.95 | 1.5 | 4.00 |
| 1.5 | 0.82 | 1.22 | 4.8 |
| 2 | 0.71 | 1.41 | 4.24 |
| 3 | 0.58 | 1.73 | 4.62 |
| 4 | 0.50 | 2.00 | 5.00 |
| 8 | 0.35 | 2.83 | 6.36 |
| 16 | 0.25 | 4.00 | 8.50 |
| 25 | 0.20 | 5.00 | 10.40 |

Systems provided herein can include multiple catalyst reactors that are fluidically coupled together in an assembly. In some embodiments, the catalyst reactor provided herein can include a reactor housing defining an enclosure. The housing can include an inlet for receiving an inlet fluid (e.g., heat exchanging fluid) and an outlet for flowing an outlet fluid (e.g., the heat exchanging fluid) out of the housing. The catalyst reactor assembly can be arranged within the enclosure of the reactor housing such that the heat exchanging fluid flows along at least a portion of the exterior of one or more of the catalyst reactors. The catalyst reactor assembly provided herein can include an inlet conduit fluidically coupled to the inlets of the catalyst reactors and an outlet conduit fluidically coupled to the outlets of catalyst reactors.

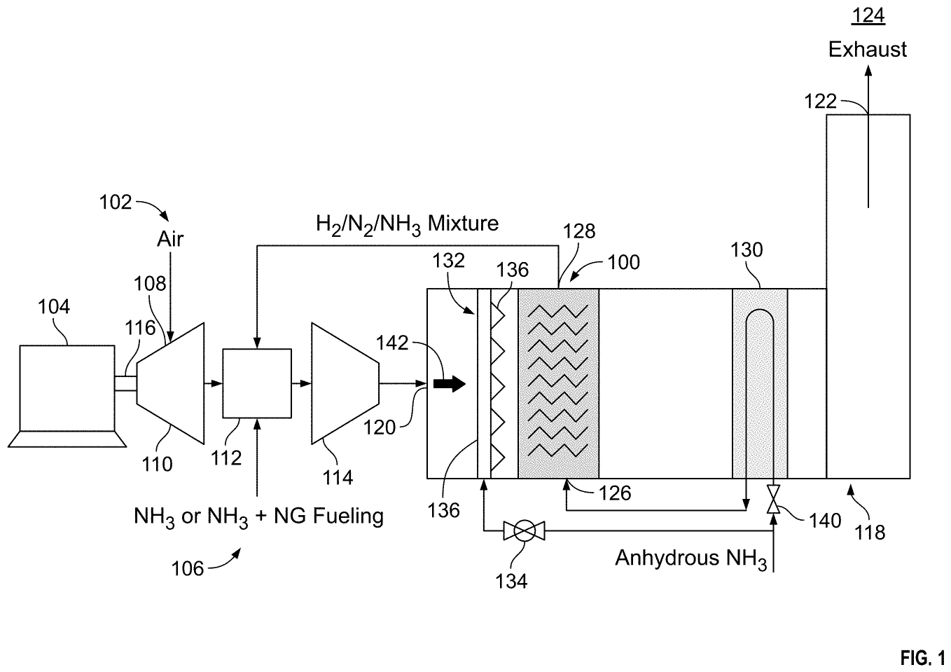

FIG. 1 is a schematic view of an exemplary catalyst reactor system 100 in a power generation system 102.

The power generation system 102 includes a generator 104 configured for generating electricity for the system. The generator 104 is powered by a gas turbine 106. The gas turbine 106 can be fueled or powered by the combustion of ammonia. Alternatively or in additionally, in some embodiments, the gas turbine 106 can be fueled by natural gas, a mixture of ammonia and natural gas, or any other petroleum based fuel.

Air can enter the gas turbine 106 at inlet 108 and be compressed by a compressor 110. The compressed air flows from the compressor 110 to a combustor 112. Fuel (in the form of ammonia, natural gas, or an ammonia/natural gas mixture) is flowed into the combustor 112. The compressed air and the fuel combine, mix, and are ignited in the combustor 112 to expand and flow to a turbine 114. Igniting the air/fuel mixture raises the temperature of the air/fuel mixture to form a hot air/fuel mixture. The hot air/fuel mixture expands in the turbine 114 causing the turbine 114 to rotate (now a hot expanded air/fuel mixture). The hot expanded air/fuel mixture can be referred to as a heat exchanging fluid.

The turbine 114 can be coupled to and rotate (e.g., powers) a shaft 116. The compressor 110 and the generator 104 can be both coupled to and rotated by the shaft 116. The shaft 116 can rotate the compressor 110 to compress the air as previously described. The shaft 116 can rotate the generator 104 to generate electricity as previously described.

The hot expanded air/fuel mixture can flow from the turbine 114 to an enclosure 118 (or a sealed housing). In some embodiments, the enclosure 118 can be an exhaust system for the power generation system 102. The enclosure 118 can include at least one inlet 120. The inlet 120 can receive the hot expanded air/fuel mixture from the turbine 114. The enclosure 118 can include at least one outlet 122. The hot expanded air/fuel mixture can flow from the inlet 120 through the enclosure 118 to the outlet 122. The hot expanded air/fuel mixture can exit the enclosure through the outlet 122 to an atmosphere 124 (the environment). In some embodiments, the flow of the hot expanded air/fuel mixture can optionally be controlled by an upstream valve (not shown), for example, in the combustor.

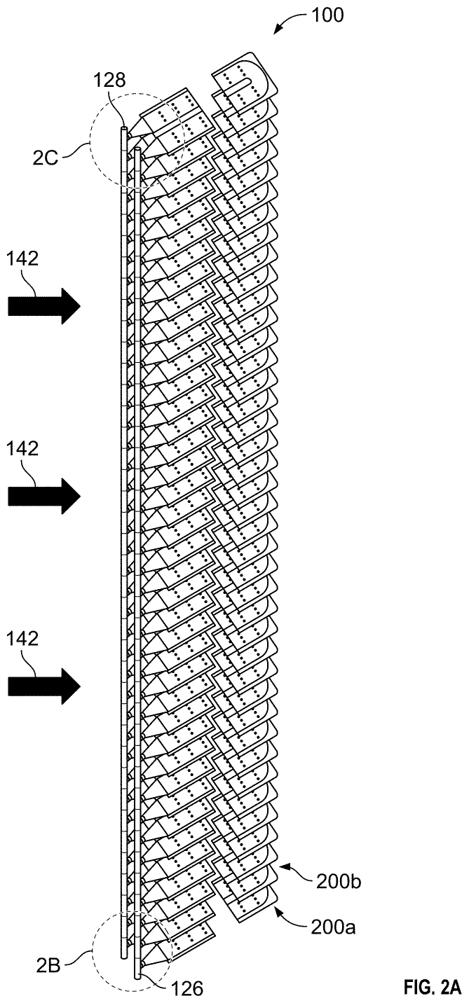

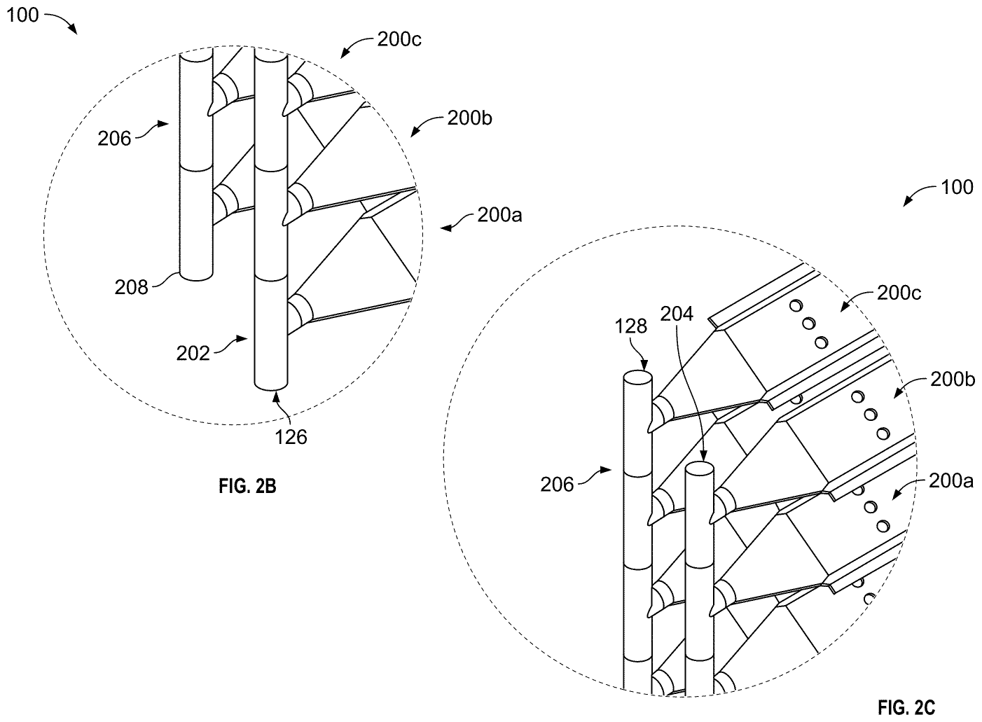

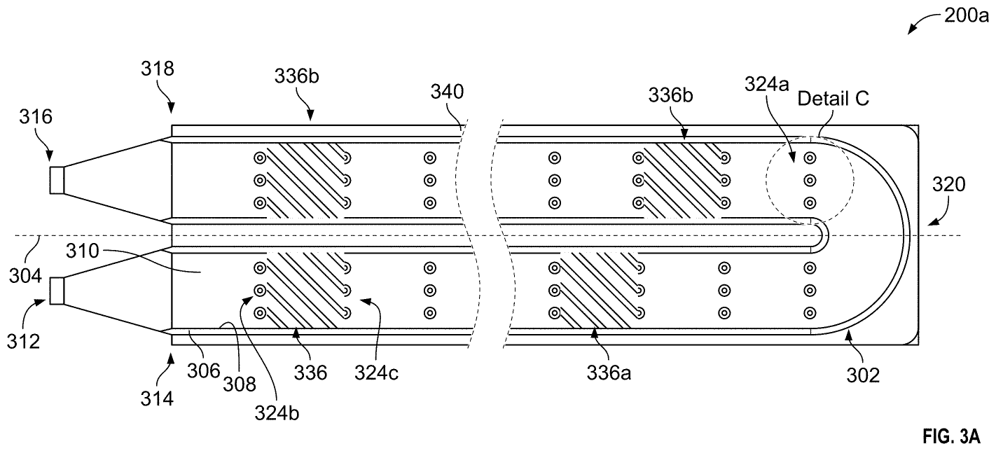

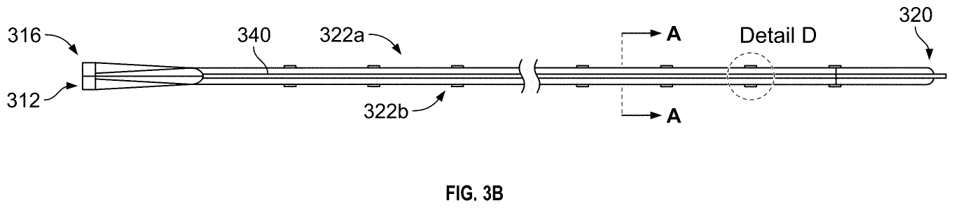

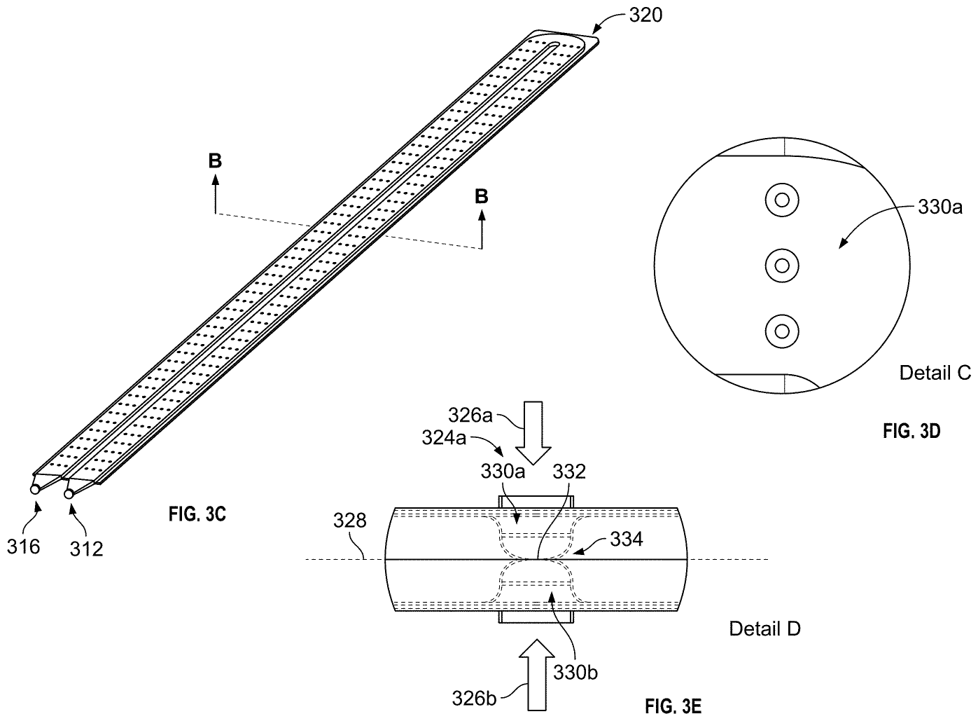

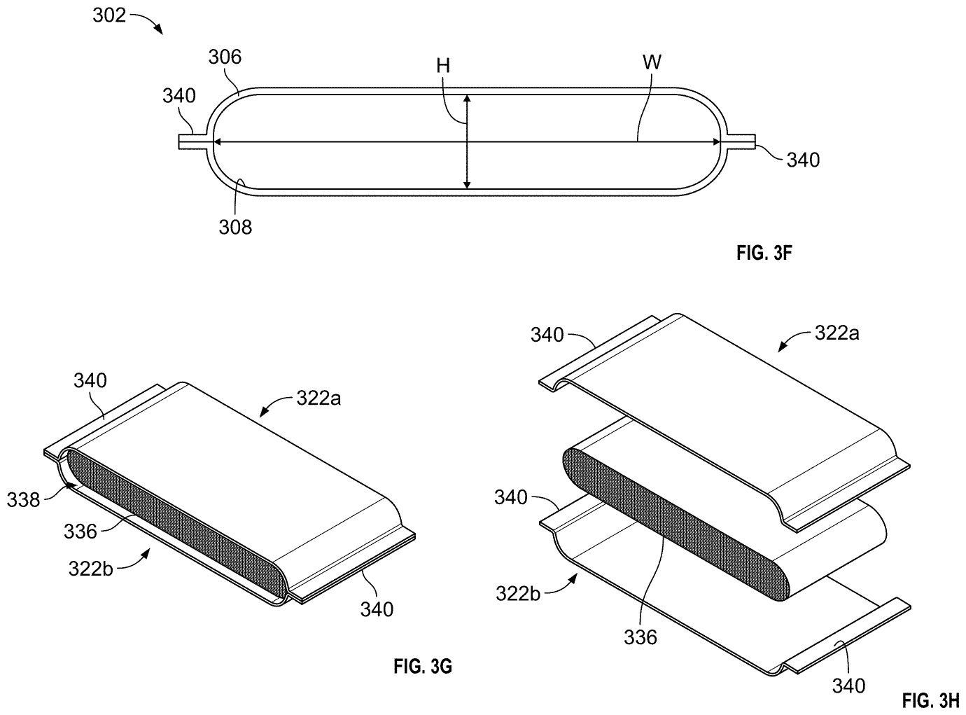

As the hot expanded air/fuel mixture flows through the enclosure 118, the mixture can flow across the catalyst reactor system 100. The catalyst reactor system 100 is described in detail below in reference to the example provided by FIGS. 2A-3C. Various embodiments of the systems and methods provided herein are configured to mix air or oxygen with ammonia such that ammonia oxidation occurs in a catalyst within the system 100 to help with the decomposition of ammonia. In some embodiments, air can be mixed at an inlet of the reactor. In some embodiments, air can be introduced or redistributed downstream of the reactor (e.g., at a mid-portion of the reactor).

The catalyst reactor system can be housed in the enclosure 118 such that the hot expanded air/fuel mixture flows across the catalyst reactor system 100, transferring heat into the catalyst reactor system 100.

The catalyst reactor system 100 can receive ammonia from at least one inlet 126. The ammonia can flow through the catalyst reactor system 100 such that the decomposition products of the ammonia and any remaining undecomposed ammonia flow to at least one outlet 128. As the ammonia flows through the catalyst reactor system 100, the ammonia can flow across one or more catalytic structures (described later in reference to FIGS. 2A-3C) housed within the catalyst reactors of the system 100. The heat transferred into the catalyst reactor system 100 can also transfer to the catalytic structures as the ammonia flows across the catalytic structure. The heat and catalytic structure can together decompose a least a portion of the ammonia to yield hydrogen and nitrogen. Some of the ammonia may not decompose and can flow out of the outlet. The ammonia flowing from the reactor described herein can be deposed in an amount from about 1 wt. % to about 100 wt. % (e.g., from about 1 wt. % to about 90 wt. %, from about 10 wt. % to about 80 wt. %, from about 20 wt. % to about 70 wt. %, or from about 40 wt. % to about 60 wt. %). Thus, the hydrogen, nitrogen, and remaining undecomposed ammonia can flow out of the outlet 128 to the combustor 112. The hydrogen, nitrogen, and remaining ammonia mix with the air and fuel in the combustor 112 and can be ignited to continue the power generation cycle.

The power generation system 102 can optionally include a heat exchanger 130. The heat exchanger 130 can receive a supply of ammonia (e.g., anhydrous ammonia). The heat exchanger 130 can be fluidically coupled to the inlet 126 of the catalyst reactor system 100 to flow the ammonia to the catalyst reactor system 100. The heat exchanger 130 can be positioned within the enclosure 118. The heat exchanger 130 can receive the hot expanded air/fuel mixture to pre-heat the ammonia before the ammonia flows into the catalyst reactor system 100.

The power generation system 102 can optionally include a duct burner 132. The duct burner 132 can receive a flow of ammonia. In some embodiments, the flow of ammonia to the duct burner 132 can be controlled by a valve 134. The duct burner 132 can include a conduit 136 to receive and flow the ammonia. The duct burner 132 can include one or more nozzles 138 extending radially from the conduit 136 to receive and inject the ammonia from the conduit 136 into the enclosure 118. As the ammonia is injected into the enclosure 118 from the nozzles 138, the ammonia can be ignited. In some embodiments, burning the ammonia can raise the temperature of the air/fuel mixture flowing through the enclosure 118.

The catalyst reactor system 100 can optionally include at least one valve 140 configured to control the flow of ammonia to the heat exchanger 130. In some embodiments, a valve can be used to control the flow of ammonia to the catalyst reactor system 100.

FIGS. 2A-2C show an exemplary catalyst reactor system 100. As shown in FIG. 2A, the catalyst reactor system 100 has at least one inlet 126 and at least one outlet 128 and includes multiple catalyst reactor assemblies. The multiple catalyst reactor assemblies can be arranged in a vertically stacked configuration. In some embodiments, multiple catalyst reactor assemblies can be arranged in a horizontal repeating configuration. In some embodiments, multiple catalyst reactor assemblies can be arranged in two or more different repeating configuration. In some embodiments, at least a portion of the catalyst reactor assemblies can be fluidically coupled via one or more conduits. For example, a first catalyst reactor assembly 200a can be mechanically and fluidically coupled to a second catalyst reactor assembly 200b. The second catalyst reactor assembly 200b can be substantially similar to the first catalyst reactor assembly 200a, as shown in FIG. 2A. In some embodiments, the second catalyst reactor assembly 200b can have a different structural shape than the first catalyst reactor assembly 200a. The first catalyst reactor assembly 200a is fluidically and mechanically coupled to the inlet 126 through which the ammonia flows into the catalyst reactor system 100.

Referring to FIG. 2B, which is a magnified view of a select portion of the catalyst reactor system of FIG. 2A, the catalyst reactor system 100 can include at least one inlet conduit 202. The ammonia can flow from the inlet 126 of the system (FIG. 2A) and into the inlet conduit 202. The first catalyst reactor assembly 200a can be mechanically and fluidically coupled to the second catalyst reactor assembly 200b by the inlet conduit 202. The FIG. 2B is a perspective view of Referring to FIG. 2B, a third catalyst reactor assembly 200c is fluidically and mechanically coupled to the second catalyst reactor assembly 200b by the inlet conduit 202. The third catalyst reactor assembly 200c can be substantially similar in size and shape to the first catalyst reactor assembly 200a and the second catalyst reactor assembly 200b. The ammonia can flow into the inlet 126. The inlet conduit 202 can be fluidically coupled to one, some, or all of the catalyst reactor assemblies 200a, 200b, and 200c. The ammonia can flow through the inlet conduit 202 to one, some, or all of the catalyst reactor assemblies 200a, 200b, and 200c. The inlet conduit 202 can include, but not limited to, welded steel or stainless steel (e.g., two inch schedule 40 pipe material).

FIG. 2C is a magnified view of a select portion of the catalyst reactor system of FIG. 2A. As shown, a terminal end 204 of the inlet conduit 202 can be optionally capped to terminate the flow of ammonia and direct the ammonia into the each of the catalyst reactor assemblies 200a, 200b, and 200c.

Still referring to FIGS. 2A-2C, the catalyst reactor system 100 includes at least one outlet conduit 206. As shown in FIG. 2B, a terminal end 208 of the outlet conduit 206 can be optionally capped to terminate the flow of ammonia and direct the ammonia into the each of the catalyst reactor assemblies 200a, 200b, and 200c. The ammonia can flow through one, some or each of the catalyst reactor assemblies 200a, 200b, and 200c into the outlet conduit 206. The first catalyst reactor assembly 200a can be mechanically and fluidically coupled to the second catalyst reactor assembly 200b by the outlet conduit 206. The third catalyst reactor assembly 200c can be fluidically and mechanically coupled to the second catalyst reactor assembly 200b via the outlet conduit 206. In some embodiments, the catalyst reactor assemblies 200a, 200b, and 200c are thermo-chemical recuperators. The outlet conduit 206 can made from welded steel or stainless steel (e.g., two-inch schedule 40 pipe material).

In some embodiments, the outlet conduit 206 can be common to some or all the catalyst reactor assemblies 200a, 200b, and 200c. The ammonia can flow into the inlet 126. The ammonia can flow through each of the catalyst reactor assemblies 200a, 200b, and 200c. Nitrogen, hydrogen, and undecomposed ammonia can flow from the catalyst reactor assemblies 200a, 200b, and 200c into the outlet conduit 206. The nitrogen, hydrogen, and undecomposed ammonia can flow through the outlet conduit 206 to the outlet 128. An outlet terminal end 208 of the outlet conduit 206 can be capped to terminate the flow of nitrogen, hydrogen, and undecomposed ammonia and direct the nitrogen, hydrogen, and undecomposed ammonia from each of the catalyst reactor assemblies 200a, 200b, and 200c and force the nitrogen, hydrogen, and undecomposed ammonia to the outlet 128.

Referring to FIGS. 1 and 2A, the hot expanded air/fuel mixture (the heat exchanging fluid) can flow through the enclosure 118 in the direction of arrow 142. The catalyst reactor assemblies 200a, 200b, and 200c can be angled relative to the heat exchanging fluid flow (the direction of arrow 142). In some cases, the catalyst reactor assemblies 200a, 200b, and 200c can be angled to induce a turbulence in the heat exchanging fluid. Inducing turbulence in the heat exchanging fluid can help increase the transfer of heat from the heat exchanging fluid to the catalyst reactor assemblies 200a, 200b, and 200c.

FIG. 3A is an exemplary catalyst reactor assembly 200a. As shown, the catalyst reactor assembly 200a includes an inlet 312. The inlet 312 can be coupled to a first end 314 of the elongated conduit 302. The inlet 312 can be mechanically and fluidically coupled to the inlet conduit 202 (shown in FIGS. 2A-2C). The inlet 312 can flow the ammonia from the inlet conduit 202 to an elongated conduit 302.

The catalyst reactor assembly can include the elongated conduit 302. The elongated conduit 302 can extend along a longitudinal axis 304. The elongated conduit 302 is defined by a wall 306. The wall 306 has an inner surface 308. The wall 306 and the inner surface 308 define an interior cavity 310. The elongated conduit 302 flows the ammonia from the inlet 312 to an outlet 316.

The wall 306 has an interior cross-section defined by a major axis, W, and a minor axis, H. The major axis, W, and a minor axis, H, define an aspect ratio,

$$α = \frac{W}{H} \qquad Equation 1$$

The aspect ratio, α, was determined using the following method. Two equal-volume catalyst structures (described later), identically coated and under identical flow and thermal conditions were used. Resistance to heat transfer due to conduction and convection was be approximated by a single thermal resistance value, which is constant between the two geometries. The thermal resistance to heat transfer scales with the thermal path length moving from a hot exterior (exhaust-side) to an endothermic reaction interior (ammonia decomposing). Temperature is constant for a given exhaust temperature surrounding the catalyst assembly. Heat transfer rate scales with the available surface area exposed to the exhaust. Increasing heat transfer to the catalyst structure is accomplished by flattening the catalyst structure proportional to the product of surface area increase and the inversely proportional to the thermal resistance decrease (increase in conductance) over a baseline geometry cross-section (cylindrical tube). For the calculation of a surface area of a shape, see Equations 10-12, below.

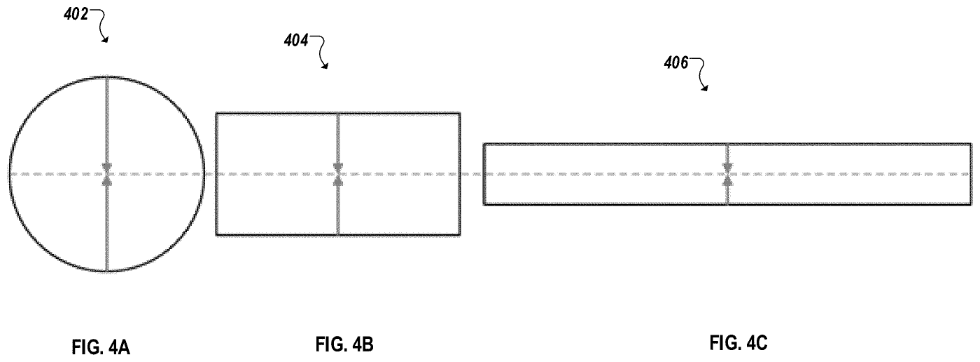

Referring to FIGS. 4A-4C, there are various geometries that can be used for the catalyst structure described herein. FIGS. 4A-4C and Table 1 show that an increasing surface area can correlate to a decreasing thermal resistance path length. FIG. 4A shows a circular cross-section 402 with a flow path length equal to the radius of the circle (R₁). FIG. 4B shows a first rectangular cross-section 404 with a flow path length equal to the 0.625 times radius of the circle (R₁). FIG. 4C shows a second rectangular cross-section 406 with a flow path length equal to the 0.313 times radius of the circle (R₁). The volume of each of the geometries of FIGS. 4A-4C are equal at 3.14 times the length (L).

TABLE 2
Increasing Surface Area and Decreasing
Thermal Resistance Path Length

| | | | | | Surface | |
|---|---|---|---|---|---|---|
| | | | | | Area | |
| | | Path | | Surface | Increase | Aspect |
| FIG. | Shape | Length | Volume | Area | (%) | Ratio |
| FIG. 4A | Circle | R | 3.14*L | 6.28*L | Base- | 1:1 |
| | | | | | line | |
| FIG. 4B | Rectangle 1 | 0.625*R | 3.14*L | 7.5*L | 19.4 | 2:1 |
| FIG. 4C | Rectangle 2 | 0.313*R | 3.14*L | 11.25*L | 79.1 | 4:1 |

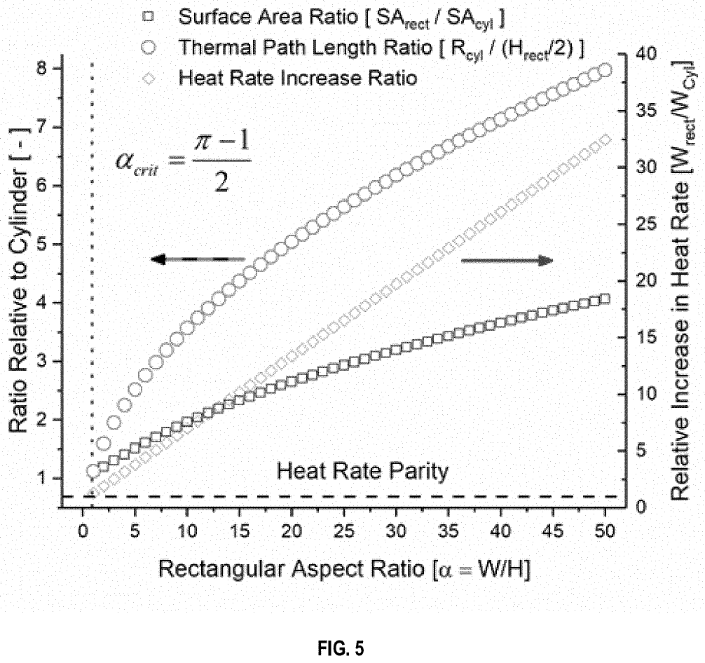

The benefit to the flatter catalyst structure is shown in FIG. 5. FIG. 5 is a chart of the effect of aspect ratio on thermal transport in identical volume and cross-sectional area catalysts. The derivations for FIG. 5 are described below. Flatness is characterized by the aspect ratio of the rectangular geometry, width over height. Heat enters the catalyst structure from the entire exposed perimeter. Heat transfer equivalence is reached at a critical aspect ratio, which is nearly approximated by unity. The circular baseline is equal to 1 on both ordinate axes. The exemplary design described herein (e.g., see FIGS. 2A-3H) has an aspect ratio of ˜14, leading to a 1000% increase in an effective heating rate over an equivalent tubular reactor (e.g., an aspect ratio of ˜1).

FIG. 5 shows the thermal benefits achieved for equal volumes of catalyst structure. The rectangular alternative thermal qualities are shown as the aspect ratio (width over length) is varied. Heat rate is approximated based on constant temperature differential and identical resistance to thermal transport inside the monolith. Effects of contact resistance and conductive resistance through the casing of the catalyst were not included. The trends provided in FIG. 5 show the effect of flattening a catalyst (e.g., increasing the aspect ratio) from cylindrical profile to rectangular on thermal transport.

High rates of heat transfer from exhaust to reaction deplete energy from the exhaust flow, decreasing the temperature differential over that of the cylindrical profile. The assumption that heat transfer resistance is linear is discussed below. Given a constant linear resistance value R in W/m-k, resistance from R to a depth of 0.606 R is equal to that of the linear resistance halfway through the rectangular catalyst (H/2).

Heating to greater depths within the cylinder can become more difficult. Furthermore, the approximation that the resistance to heating scales with thermal path length in the cylindrical geometry cab slightly over-estimate the cylindrical heat rate, while also underestimating the benefit of the rectangular geometry.

V_{cyl}=πr²L Equation 2

V_{rect}LWH Equation 3

Assuming a constant space velocity, and therefore identical catalyst volumes, yields:

V_{cyl}=V_{rect} Equation 4

πr²L=LWH Equation 5

πr²=WH Equation 6

Defining a variable for the “flatness” of the rectangular catalyst, as discussed above, the aspect ratio is:

$$α = \frac{W}{H} \qquad Equation 1$$

Defining W in terms of H yields the following equation:

W=αH Equation 7

Rewriting Equation 6 yields:

πr²=αH² Equation 8

Simplifying to find H in terms of radius, a relationship between radius of a cylinder and the height of a rectangular prism is defined. For varied aspect ratios, the volume of the rectangular prism and the cylinder are equal, see for instance Table 2.

$$r \sqrt{\frac{π}{α}} = H \qquad Equation 9$$

The height (H) and radius (R) are considered as the effective path-length across which heat must flow. The longer path length increases thermal resistance and decreases heating rate, assuming all other variables are held constant.

The other half of the heat rate estimation involves the relative surface area of the catalyst geometry. The generic surface areas of cylindrical and rectangular geometries are defined below.

SA_{syl}=2πrL Equation 10

SA_{rect}=2(W+H)L

The ratio of surfaces areas is, through several substitutions:

$$S {A}_{R A T I O} = \frac{( α H + H )}{π r} = \frac{H ( α + 1 )}{π r} = \frac{r \sqrt{\frac{π}{α}} ( α + 1 )}{π r} = \frac{α + 1}{\sqrt{απ}} \qquad Equation 12$$

Assuming thermal properties and conditions on both cylindrical and rectangular catalysts are equal, an estimation of heat transfer rate increase can be obtained by the product of the ratio of surface areas the inverse of thermal path length (e.g., overall thermal conductivity).

The ratio of effective conductivities is given by the inverse ratio of thermal path lengths R over H/2. The H/2 term is included as heat enters the rectangular monolith from both ends.

$${}^{″} {{Conductivity}_{RATIO}}^{″} \approx \frac{2 r}{H} = \frac{2 r}{r \sqrt{\frac{π}{α}}} = 2 \sqrt{\frac{α}{π}} \qquad Equation 13$$

The ratios are multiply together:

$$\frac{α + 1}{\sqrt{απ}} \cdot 2 \sqrt{\frac{α}{π}} = \frac{2 ( α + 1 )}{π} \qquad Equation 14$$

The critical aspect ratio, α, is the value at which the relative heat transfer of the two geometries is equal. Geometries having an aspect ratio value that is above the critical aspect ratio (e.g., rectangular geometries) transfer more heat.

$${α}_{crit} = \frac{π - 1}{2} \approx 1.071 \qquad Equation 15$$

The radial heat transfer in cylinders is not accounted for in this proof. Heat transfer is not linear as heat moves radially through a cylinder. Using the full volume of a cylinder may decrease the area upon which heat flows through.

In some embodiments, to acquire a higher surface-area to volume ratio, as is the case of a round tube, the tube may be flattened to produce an oval or slot profile. Aspect ratios at 2.0 or above provide heat-transfer advantages over a round (e.g., cylindrical) tube, as discussed above. In some embodiments, the aspect ratio is greater than or equal to 2.0 (e.g., greater than or equal to 2.5, greater than or equal 3.0, greater than or equal to 3.5, greater than or equal to 4.0, greater than or equal to 5.0, greater than or equal to 10, greater than or equal to 20, greater than or equal to 30, or greater than or equal to 50).

A thermal analysis can be used to establish an upper bound of the aspect ratio. Flattening the geometry, e.g., obtaining higher aspect ratios, decreases thermal resistance between the interior fluid and the exterior fluid. Low thermal resistance increases the average temperature of the catalyst and fluid inside, increasing activity and yield. Lowering thermal resistance can create diminishing yields, as eventually the interior catalyst and fluid are at a uniform temperature, limited by the convective heat transfer rate and the thermal resistance of the fixed heat exchanger wall thickness and internal convective rates. In this condition, the average temperature of the catalyst and internal fluid system are near the maximum temperature they can reach under their flow rates and initial temperatures. Treating the whole internal volume (Fluid+Catalyst) as a fixed mass, with temperature and an effective thermal conductivity, determining heat transfer using the Biot Number (Bi) facilitates quantification of performance.

Bi compares the rate of external convection to internal conduction and determines whether the internal conduction is sufficient to treat the inner volume as having uniform temperature. If conduction is sufficient such that the internal temperature variation is negligible, increasing the aspect ratio to decrease thermal resistivity does not result in further thermal benefit. This condition occurs when Bi≤0.1 and particularly when Bi«0.1.

The Biot Number (Bi) is defined as:

$${B}_{i} = \frac{h}{k} l , \qquad Equation 16$$

where h is the convective heat transfer coefficient defined as

$$h = [ \frac{W}{{m}^{2} - K} ] , \qquad Equation 17$$

k is the reactor conductivity defined as

$$k = [ \frac{W}{m - K} ] , \qquad Equation 18$$

and l is the reactor half-thickness, and t the reactor thickness.

To define a maximum width of a rectangular reactor unit, a constraint is common material sizes from which the reactor unit is stamped and welded. Widths of 48 inches are common for sheet stock, which is then cut to shorter lengths with a shear or other method. Wider widths may incur costs related to specially ordered stock and smaller width units can be easier to handle during manufacturing. This determines an upper bound on the aspect ratio once the thickness is determined.

Using the first Bi constraint above, in which Bi is less than or equal to 0.1, it is also true that

$$B i = \frac{h}{k} l \leq 0.1 \qquad Equation 19$$

$$or$$

$$Bi = \frac{h}{k} \frac{t}{2} \leq 0.1 \qquad Equation 20$$

$$therefore$$

$$t \leq \frac{0.2 k}{h} \qquad Equation 21$$

To determine a theoretical maximum aspect ratio, the minimum thickness is determined. Increasing convective rates and decreasing conduction rates results in a smaller thickness for thermal homogeneity. To consider from another angle, high conduction rates create conditions for a thick (e.g., high t) reactor cross-section and increased performance compared to low conduction rates. The term ‘thick’ in this case refers to the thermal path length, or the total length heat travels through the material before reaching a boundary. In the case of our flattened plate which is heated from both ends, this is half way through the physical thickness of the flattened plate. As thermal conductivity tends to be low in catalyst substrates due to large open areas, it is desirable to be thinner, e.g., high aspect ratios.

If convection is weak, a thinner plate does not increase and homogenize the internal temperatures. Internal temperatures are homogeneous when the internal temperatures are at a lower temperature than the external exhaust gases. High resistance at the convective boundary layer is where most of the temperature differential exists, leaving less to generate inhomogeneity in the reactor itself. High convective coefficients and high conductivity are desirable. To define a maximum aspect ratio, assumptions are made that conduction is low and convection is high. For example, an assumption is that the minimum conduction is equal to the effective conduction of the metal catalyst support and/or sheet which contain the catalyst, e.g., stainless steel properties.

$${k}_{min} = 20 [ \frac{W}{m - K} ] \qquad Equation 22$$

Established ranges for forced convection of gas, as determined in a gas turbine are

$$100 \leq {h}_{c o n v} \leq 500 [ \frac{W}{{m}^{2} - K} ] \qquad Equation 23$$

Taking the largest convection rate to find our maximum aspect ratio:

$$α \leq \frac{h w}{0.2 k} = \frac{( 500 ) ( 1.209 )}{0.2 ( 20 )} = 151.125 \approx 150 \qquad Equation 24$$

This results in a thin plate. This provides an upper bound for the aspect ratio where thinner can become a manufacturing issue, though this is not theoretically limiting on manufacturing processes themselves. Above this aspect ratio provides diminishing additional thermal benefit under extreme conditions. For less extreme cases, (e.g., for example, 50≤α≤100, e.g., 75), it may be feasible to make a reactor section at 24″ and similar thicknesses to achieve a design resulting in an aspect ratio of ˜75 as well as facilitating easier manufacture. In some embodiments, the aspect ratio is less than or equal to 150 (e.g., less than or equal to 125, less than or equal 100, less than or equal to 80, less than or equal to 75, less than or equal to 70, less than or equal to 50, less than or equal to 20, or less than or equal to 10). In some embodiments, the aspect ratio is in a range from 2 to 150 (e.g., in a range from 5 to 125, in a range from 10 to 100, in a range from 50 to 80, in a range from 65 to 75, in a range from 70 to 80, in a range from 50 to 100, in a range from 20 to 125, in a range from 10 to 30, in a range from 20 to 50, in a range from 20 to 40, in a range from 5 to 20, or in a range from 10 to 20).

Additionally or alternatively, producing thicker and sturdier panels is possible for convections below

$$500 [ \frac{W}{m - k} ]$$

and/or about

$$100 [ \frac{W}{m - k} ] .$$

An aspect ratio of 150 represents a theoretical upper bound based on assumptions for what is impractical for common real-world applications known in the art.

The internal heat generation (e.g., absorption) term due to chemical reaction is another factor for consideration which changes effective conduction within the reactor. In the non-limiting case described, the reactor absorbs heat from the chemical reactions, which increase the effective conductivity term by generating a greater temperature gradient than that without reaction. In the above analysis, a lower bound on this term is assumed so in the case of internal generation where conductivity goes up, the same heat exchange performance with smaller aspect ratio is achieved.

The aspect ratio upper limit of 150 is an upper bound as determined based on the assumptions described and is non-limiting for applications in which the assumptions are modified or alternative methods are utilized. Assuming a lower bound on the generation term embodies the condition where the internal fluid flows and absorbs heat without reacting. This is a condition in a preheating step as opposed to a reaction step. In conditions in which a reaction step is occurring, the methods and system described facilitate achieving comparable outcomes, e.g., part of a reactor section, or some of all reactor sections are used for pre-heating instead of reaction.

For the cylinder and rectangle described above, the effective resistance into the radial volume becomes equal to the half-height resistance of the rectangle at a radial depth of ˜0.41 of radius as described below. Cylindrical surface area is the same as rectangular surface area when considered for thermal resistance. An arbitrary and equal “conduction” value k is used to represent heat transfer. The effective length in rectangular resistance is equal to the H/2, which is also the outer radius of the cylinder/2. A critical depth for r₂ yields an equivalent resistance to the rectangular resistance, and is non-negative.

$${R}_{th} = \frac{ln ( {r}_{1} / {r}_{2} )}{2 π kL} = \frac{\frac{h}{2}}{k A} \qquad Equation 25$$

$${A}_{cyl} = {A}_{surf , rect} = 2 π {r}_{1} L \qquad Equation 26$$

$${R}_{th} = \frac{ln ( {r}_{1} / {r}_{2} )}{2 π kL} = \frac{\frac{{r}_{1}}{2}}{k 2 π {r}_{1} L} \qquad Equation 27$$

Find the critical value for r₂ is found by:

$$\frac{ln ( {r}_{1} / {r}_{2} )}{2 π kL} \geq \frac{\frac{{r}_{1}}{2}}{k 2 π {r}_{1} L} \qquad Equation 28$$

$$\frac{k 2 π {r}_{1} L * ln ( {r}_{1} / {r}_{2} )}{\frac{{r}_{1}}{2} 2 π kL} \geq \frac{1}{1} \qquad Equation 29$$

$$ln ( {r}_{1} / {r}_{2} ) \geq \frac{1}{2} \qquad Equation 30$$

$$\frac{{r}_{1}}{{r}_{2}} \geq {e}^{\frac{1}{2}} \qquad Equation 31$$

$${e}^{- \frac{1}{2}} {r}_{1} \approx 0.606 {r}_{1} \geq {r}_{2} \qquad Equation 32$$

Under these conditions, as long as the thermal path length in the cylindrical baseline is greater than 0.394 r, the resistance is greater for the cylinder than the rectangle.

One benefit of the flat plate rectangular geometry is maximizing the surface area with a single catalyst structure using a monolith catalyst, as described later.

Returning to the description of the elongated conduit 302, referring to FIGS. 3A-3H, the elongated conduit 302 includes a u-shaped section 320. The u-shaped section 320 directs the flow of ammonia through the elongated conduit 302, from the inlet 312 to the outlet 316, which are generally located proximal to each other. The u-shaped section 320 can be referred to as a two-pass serpentine. A two-pass serpentine shape can reduce the thermal variation in the elongated conduit 302 along its longitudinal axis 304. In some embodiments, more than two passes can be utilized (e.g., a 3-pass, 4-pass, 5-pass, 10-pass, or greater than 10 pass shape) in a conduit shape.

The elongated conduit 302 can be manufactured from steel, stainless steel, any ferrous alloy, or combinations thereof

FIG. 3B is a side view of the catalyst reactor assembly of FIG. 3A. As shown in FIG. B, the elongated conduit 302 includes a first shell 322a. The elongated conduit 302 includes a second shell 322b. The second shell 322b couples to the first shell 322a. The first and second shells 322a and 322b couple together to define the elongated conduit 302. For example, the first and second shells 322a and 322b can be stamped, with their edges 340 rolled and/or welded together.

FIG. 3D is a top view of detail C of the catalyst reactor assembly of FIG. 3A. FIG. 3E is a cross-sectional view of detail D of the catalyst reactor assembly FIG. 3B. As shown in FIGS. 3A-3D, the elongated conduit 302 includes a stamped portion 324a that recesses the wall 306 in a transverse direction as shown by arrows 326a and 326b (in FIG. 3E) toward a central axis 328 of the wall 306 of the elongated conduit 302. The stamped portion 324a includes two opposing wall portions 330a and 330b that are each recessed in a transverse direction (as shown by arrows 326a and 326b) toward the central axis 328 of the elongated conduit 302 and are coupled together at location 332. The stamped portion 324a can provide structural support and contribute to flow turbulence which can increase heat transfer.

The elongated conduit 302 includes multiple stamped portions 324a. For example, as shown in FIGS. 3A-3B, the elongated conduit 302 includes a second stamped portion 324b and 324c, substantially similar to stamped portion 324a.

As shown in FIG. 3E, a portion 334 of the stamped portion 324a is circular shaped. Alternatively, the portion 334 of the stamped portion 324a can be square shaped or rectangular shaped.

Referring to FIG. 3A, the catalyst reactor assembly 200a includes a catalytic structure 336 disposed within the interior cavity 310 of the elongated conduit 302. The catalytic structure 336 changes a composition of the ammonia (the first fluid) responsive to a transfer of heat across the wall 306 of the elongated conduit 302.

FIG. 3G is a cross-sectional view of the catalyst reactor assembly of FIG. 3C along cross-section B-B. FIG. 3H is an exploded cross-sectional perspective view of the catalyst reactor assembly of FIG. 3C along cross-section B-B. Referring to FIGS. 3H-3G, the catalytic structure 336 has a cross-section shape 338 is the same shape as the interior cross-section of the elongated conduit 302.

As shown in FIG. 3A, the catalytic structure 336 can include multiple catalytic structures 336a, 336b, and 336c. Each of the multiple catalytic structures 336a, 336b, and 336c can be constrained by the multiple stamped portions 324a, 32b, and 324c.

In some embodiments, the catalytic structure 336, or each of the multiple catalytic structures 336a, 336b, and 336c are catalytic monoliths.

The catalytic structures 336a, 336b, and 336c can be assembled as modules (not shown) from smaller sub-units of coated monolith which are fitted into the frame of the modules. The modules can be configured in a variety of different shapes and sizes. In some embodiments, the modules can have the same shape as the interior portion of the conduit, for example a flattened profile (e.g., see catalytic structure 336 in FIGS. 3G and 3H). In some embodiments, the modules of monoliths can be stacked plates or extruded ceramic plates. In some embodiments, the modules can be cubic modules configured for a gas turbine installation (e.g., a SCR or oxidation system). In some embodiments, the cubic modules can have side dimensions of about 0.5 meter to about 1 meter. The modules can be one or multiple rectangular prisms, for example, in some embodiments, the prisms fit within the 1-meter cube volume.

Alternatively or in addition, the catalytic structure 336, or each of the multiple catalytic structures 336a, 336b, and 336c are multiple catalyst pellets.

The catalytic structure 336 (and the multiple catalytic structures 336a, 336b, and 336c) is fixedly coupled to the elongated conduit 302. For example, the multiple catalytic structures 336a, 336b, and 336c can be fixedly coupled to the elongated conduit 302 by the multiple stamped portions 324a, 324b, and 324c as previously described. For example, as shown in FIGS. 3G-3H, the catalytic structure 336 is coupled to the elongated conduit 302 by an interference fit.

The catalytic structure 336 can generally include any active catalyst material (e.g., catalytic nanoparticles) supported on a substrate. For example, in some embodiments, catalytic structure 336 can include a catalyst formulation that is coated (e.g., wash-coated) on a substrate. In some embodiments, the catalyst formulation can be coated on the substrate directly or formed into particles or pellets. In some embodiments, the catalytic structure includes a catalyst formulation in the form of a washcoat, which is a high porosity ceramic material containing active catalyst metals. In some embodiments, the catalyst washcoat materials and substrates can optionally include adsorption materials, for example, zeolites.

The catalyst substrate can include pellets, a ceramic monolith, a metal monolith, or combinations thereof. In some embodiments, the catalytic structure can include a ceramic, metal, or combinations thereof. In some embodiments, the catalytic structure can include a ceramic material, including but not limited to, aluminum oxide, cerium oxide, zinc oxide, or the like. In some embodiments, the catalytic structure can include cordierite. In some embodiments, the catalytic structure can include a single active material, or a combination of multiple active materials.

The catalytic structure 336 can include one or more metals. In some embodiments, the catalytic structure can include stainless steel, for example, iron-chromium-aluminum alloys commercially known as Kanthal® or FeCrAlloy.

Referring to FIGS. 2A-2C and 3A-3C, the catalyst reactor assembly 200a includes the outlet 316. The outlet 316 is coupled to a second end 318 of the elongated conduit 302. The outlet 316 is mechanically and fluidically coupled to the outlet conduit 206 (shown in FIGS. 2A-2C). The outlet 316 receives the flow of the ammonia from the elongated conduit 302.

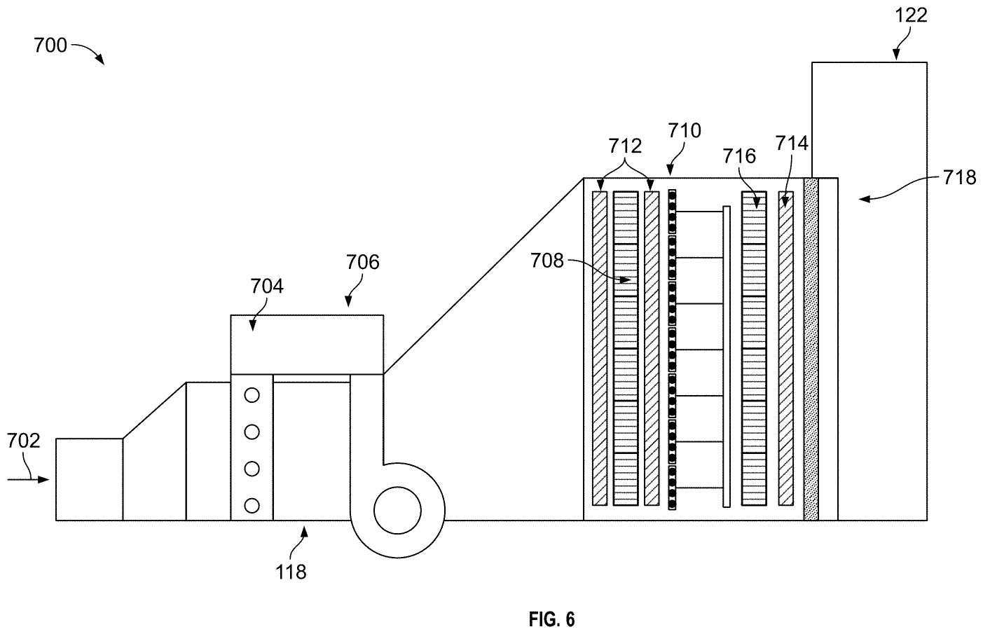

FIG. 6 illustrates another exemplary catalyst reactor system 100 incorporated into a simple-cycle gas turbine plant 700. FIG. 6 includes a detailed illustration of the enclosure 118 previously described in reference to FIG. 1. The hot expanded air/fuel mixture enters in the enclosure 118 from the turbine (not shown in FIG. 6) in the direction of arrow 702. The plant 700 can optionally include an air tempering system 704 (e.g., in simple-cycle gas turbines). The air tempering system 704 adds air from an atmosphere 706 to the enclosure 118 to adjust the temperature of the hot expanded air/fuel mixture. In some embodiments, the catalyst reactor system 100 can be incorporated into a plant 700 that does not include an air tempering system (e.g., a combined cycle plant).

In some embodiments, the catalyst reactor system 100 can be integrated into a simple-cycle gas turbine such that the need for tempering air is eliminated. The catalyst reactor system 100 can cause an ammonia decomposition reaction that cools the exhaust and reclaims waste energy. In various embodiments, both oxidation and SCR catalysts are present in the plant.

In some embodiments, the catalyst reactor system 100 can be arranged upstream of the oxidation and/or SCR catalyst. In some embodiments, the catalyst reactor system 100 upstream of the oxidation and/or SCR catalysts. While the catalysts provide a small increase in process temperature, in some embodiments, it may be advantageous to move the reactor to a location far upstream where temperatures are much higher (e.g., temperatures are significantly higher near the duct burner than near the SCR assembly). This would be especially useful if a lower activity catalyst was to be used. Process heat generated after the catalysts would still be recovered through non-catalytic preheating/vaporizing of the ammonia.

The plant 700 can include an oxidation catalyst assembly 708. In some embodiments, the oxidation catalyst assembly 708 can optionally use chemical heat provided by a selective catalytic reduction (SCR) catalyst to partially decompose ammonia to hydrogen and nitrogen at concentrations suitable for complete combustion.

The plant 700 can include an ammonia injection grid 710, substantially similar to the duct burner previously described. The catalyst reactor system 100 can be positioned in the enclosure 118 before the oxidation catalyst assembly 708 at location 712. The catalyst reactor system 100 can be positioned proximal (location 712) to an output of an oxidation catalyst assembly 708 of the heat recovery steam generator plant 800 such that a threshold quantity of heat is transferred from the oxidation catalyst assembly 708 to the catalyst reactor system 100.

The plant 700 can include a reduction catalyst assembly 716. Alternatively, the catalyst reactor system 100 can be positioned in the enclosure 118 after the reduction catalyst assembly 716 and the ammonia injection grid 710 at location 714. The catalyst reactor system 100 can be positioned proximal to an output of a reduction catalyst assembly 716 of the plant 700 such that a threshold quantity of heat is transferred from the reduction catalyst assembly 716 to the catalyst reactor system 100.

The plant 700 can include an exhaust stack 718. The exhaust stack 718 includes the outlet 122 previously described in reference to FIG. 1.

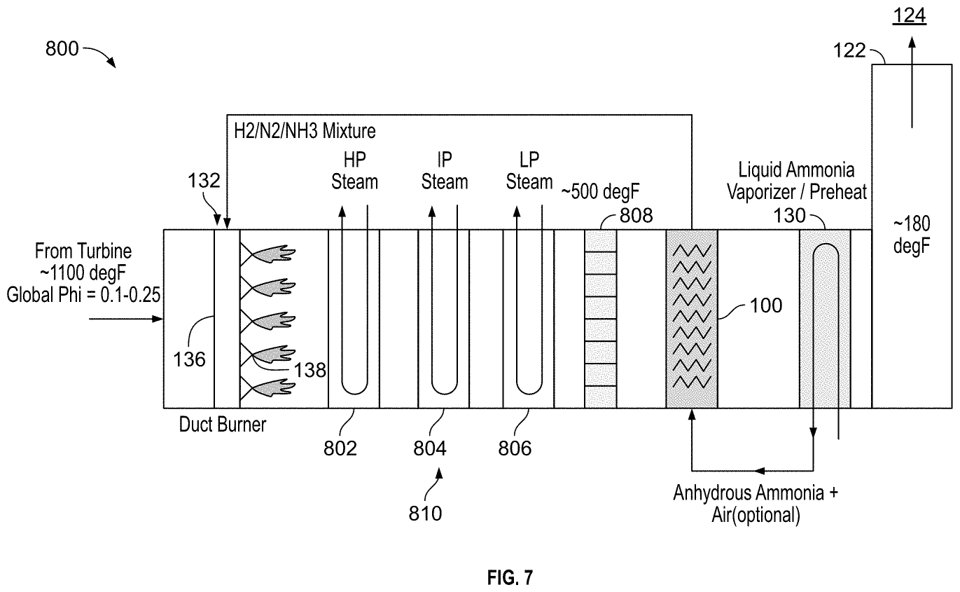

FIG. 7 illustrates an exemplary catalyst reactor system 100 incorporated into a heat recovery steam generator plant 800. The heat recovery steam generator plant 800 is generally similar to the power generation system 102 previously described. In the heat recovery steam generator plant 800, the ammonia is partially-reacted to produce hydrogen in the catalyst reactor system 100 and then burned in a duct burner 132. Supplemental heat from the duct burner 132 is used for the steam generator 810. Unburned ammonia from duct burner 132 is used for removing nitrogen oxides in a selective catalytic reduction catalyst reactor 808 (described below). The steam generator 810 includes a first heat exchanger 802, a second heat exchanger 804, and a third heat exchanger 806. The heat exchanger 802 is a high pressure steam heat exchanger. The heat exchanger 804 is an intermediate pressure steam heat exchanger. The heat exchanger 806 is a low pressure steam heat exchanger.

The heat recovery steam generator plant 800 includes a selective catalytic reduction catalyst reactor 808. The catalyst reactor system 100 is positioned in the enclosure 118 after the first heat exchanger 802, the second heat exchanger 804, the third heat exchanger 806, and the selective catalytic reduction catalyst reactor 808.

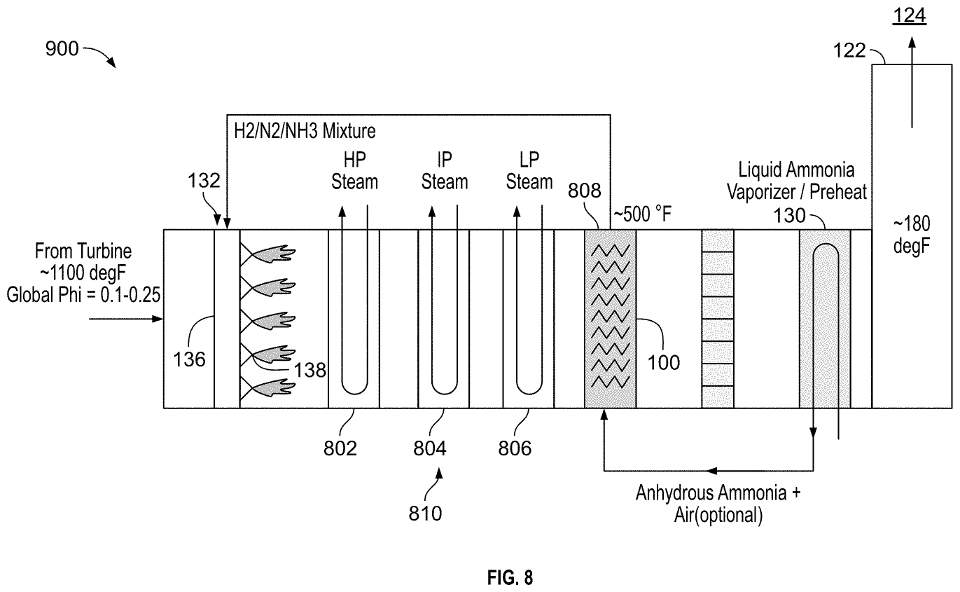

FIG. 8 illustrates another exemplary catalyst reactor system 100 incorporated into another heat recovery steam generator plant 900 in an alternate location. The heat recovery steam generator plant 900 is generally similar to the heat recovery steam generator plant 800 previously described. The ammonia in the catalyst reactor system 100 is placed upstream of the selective catalytic reduction catalyst reactor 808. Positioning the catalyst reactor system 100 further upstream can improve recuperation and/or hydrogen production depending on the exhaust specifics of the turbine (not shown in FIG. 8). The heat recovery steam generator plant 900 includes the first heat exchanger 802, the second heat exchanger 804, and the third heat exchanger 806.

The heat recovery steam generator plant 900 includes the selective catalytic reduction catalyst reactor 808. The catalyst reactor system 100 is positioned in the enclosure 118 after the first heat exchanger 802, the second heat exchanger 804, the third heat exchanger 806, but before the selective catalytic reduction catalyst reactor 808.

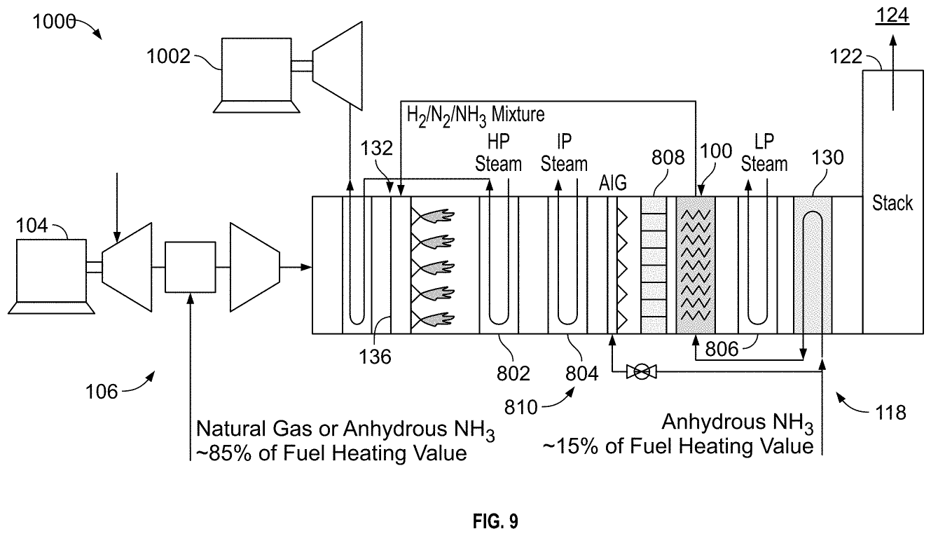

FIG. 9 illustrates an exemplary catalyst reactor system 100 incorporated into a natural gas combined cycle power plant 1000. The natural gas combined cycle power plant 1000 is generally similar to the heat recovery steam generator plant 900 previously described. The natural gas combined cycle power plant 1000 includes a second generator 1002. The second generator 1002 produces electricity.

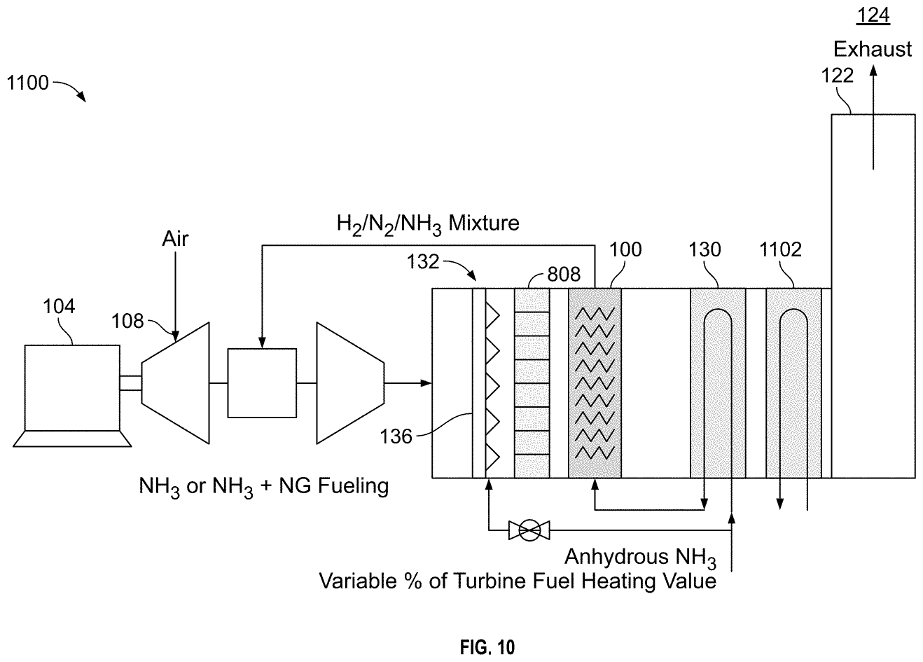

FIG. 10 illustrates an exemplary catalyst reactor system 100 incorporated into a natural gas combined heat and power plant 1100. The natural gas combined heat and power plant 1100 is generally similar to the power generator system 102 previously described. The natural gas combined heat and power plant 1100 includes the selective catalytic reduction catalyst reactor 808.

The natural gas combined heat and power plant 1100 includes a heat exchanger 1102. The heat exchanger 1102 is used for process heat recovery.

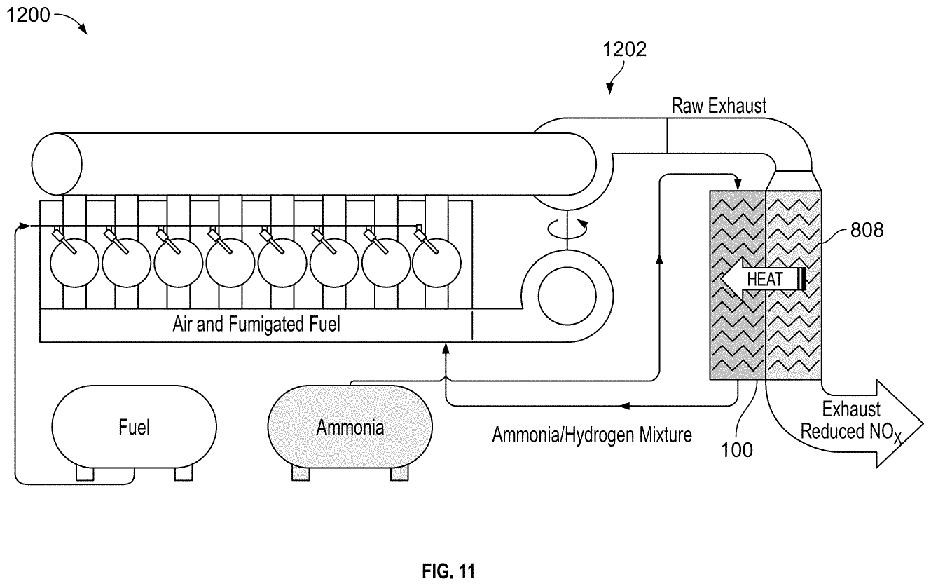

FIG. 11 illustrates an exemplary catalyst reactor system 100 incorporated into an internal combustion engine 1200. For example, the internal combustion engine 1200 can be a large marine vessel diesel engine. The catalyst reactor system 100 is positioned in the exhaust manifold 1202 to receive the heated exhaust. The selective catalytic reduction catalyst reactor 808 is positioned in the exhaust manifold 1202. The selective catalytic reduction catalyst reactor 808 is coupled to the catalyst reactor system 100 to transfer heat to the catalyst reactor system 100. As shown in FIG. 11, an ammonia fraction of fuel sent to the duct burner 132 can be modulated with a bypass for simultaneous reduction of NH₃ and NOₓ emissions.

In some embodiments, as shown in FIG. 11, a metering valve and/or mixing valve can be included in the system. In some embodiments, where an increased amount of ammonia is needed at a duct burner for efficient selective catalytic reduction (SCR) operation, the metering/mixing valve would allow for a bypass line. In some embodiments, a terminal end (e.g., 204 of FIG. 2C) of an inlet pipe (e.g., inlet pipe of 204 of FIG. 2C) may not be capped off such that the metering/mixing value can be incorporated at the terminal end (e.g., 204 of FIG. 2C) of the inlet pipe.

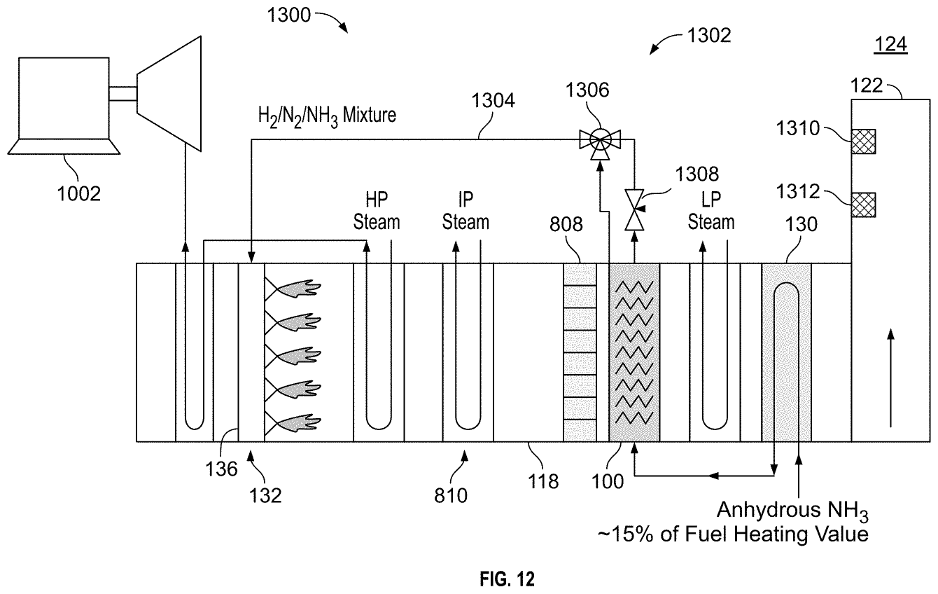

FIG. 12 illustrates another exemplary catalyst reactor system 100 incorporated into another heat recovery steam generator plant 1300. The natural gas combined heat and power plant 1300 is generally similar to the natural gas combined heat and power plant 900 previously described. The heat recovery steam generator plant 1300 includes a control system 1302.

The control system 1302 includes a mixing/bypass conduit 1304. The mixing/bypass conduit 1304 can flow a portion of ammonia from the catalyst reactor system 100 and a portion of the hot expanded air/fuel mixture from the enclosure 118 directly to the duct burner 132.

The control system 1302 includes a mixing valve 1306. The mixing valve 1306 controls the flow of the portion of ammonia around the catalyst reactor system 100 to the duct burner 132.

The control system 1302 includes a metering valve 1308. The metering valve 1308 controls and measures the flow of the portion of ammonia from the catalyst reactor system 100 to the mixing valve 1306.

The control system 1302 can include one or more sensors. For example, in some embodiments, the control system 1302 can optionally include a first sensor 1310. The first sensor 1310 can be positioned within the system, for example, at or near the outlet 122. The first sensor 1310 can be configured to sense a quantity of residual ammonia in the exhaust stream. The first sensor 1310 can transmit a signal representing the quantity of ammonia in the outlet 122 to the mixing valve 1308. The mixing valve 1308 can actuate to increase or decrease the flow of the portion of ammonia from the catalyst reactor system 100 and the portion of the hot expanded air/fuel mixture from the enclosure 118 to the duct burner 132 in response to the sensed quantity of ammonia in the outlet 122.

The control system 1302 can optionally include a second sensor 1312. The second sensor 1310 can be positioned within the system, for example, at or near the outlet 122. The second sensor 1310 is configured to sense a quantity of oxides of nitrogen (NO/NO₂) in the system (e.g., in the exhaust exiting through the outlet 122). In some embodiments, a system can dose ammonia into the exhaust to reduce NO/NO₂, and dosing can be determined by online measurement of the NO/NO₂ in the exhaust after SCR. The NO/NO₂ in the exhaust can be measured periodically to effectively dose. In some embodiments, the systems provided herein can replace an ammonia dosing system by modulating the ammonia concentration by adjusting the amount of ammonia sent to a burner/turbine as compared to hydrogen from catalytic cracking. This control can be accomplished by a simple catalyst bypass valve. Unburned ammonia from a combustion device (e.g., a turbine) may result from excess ammonia being sent to the combustion device due to the ammonia's poor burning characteristics as compared to H2. In such circumstances, unburned ammonia would be present in the exhaust stream and used as reductant for the SCR.

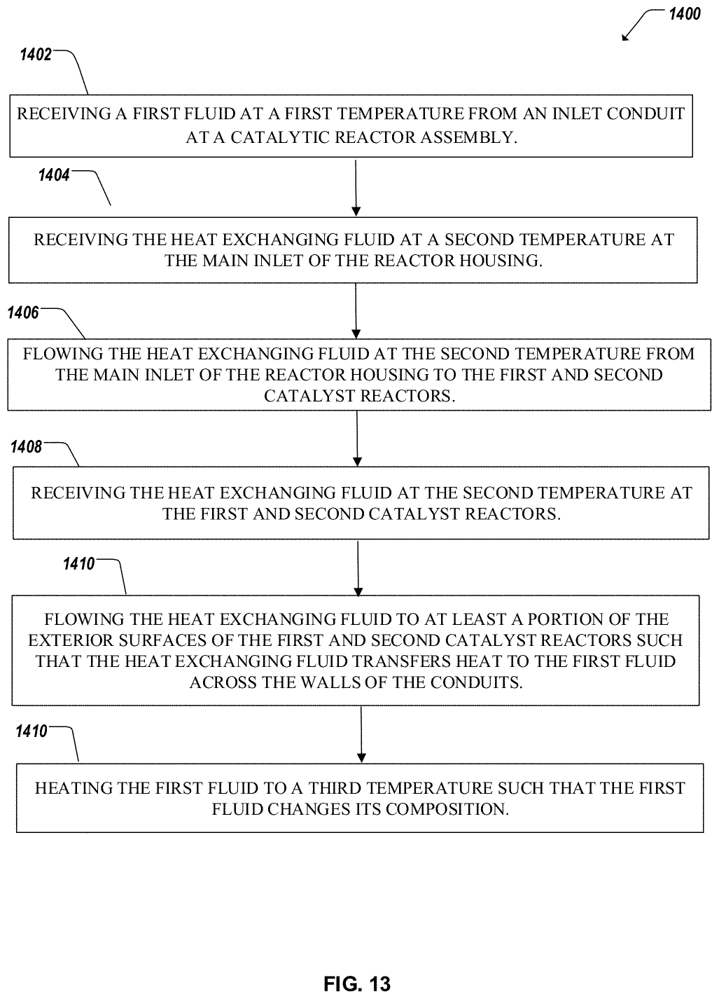

FIG. 13 is a flow chart of an example method 1400 of thermal decomposition of ammonia using a thermochemical recuperator according to the present disclosure. At 1402, a first fluid at a first temperature is received from an inlet conduit at a catalytic reactor assembly. The catalyst reactor assembly includes a first and second catalyst reactors. Each catalyst reactor includes an elongated conduit.

The elongated conduit includes a wall defining an interior cavity and an exterior surface for transferring heat from the heat exchanging fluid to the interior cavity. The elongated housing includes an inlet for receiving a first fluid. The elongated housing includes an outlet to flow the first fluid out of the elongated conduit.

The elongated conduit has an interior cross-section defined by a major dimension and a minor dimension. The major and minor dimensions define an aspect ratio, α=W/H. The aspect ratio has a value greater than 1.071.

The catalyst reactor assembly includes a catalytic structure disposed within the interior cavity of the elongated conduit.

The catalyst reactor assembly is positioned within a reactor housing defining an enclosure. The housing includes a main inlet for receiving a heat exchanging fluid and a main outlet for flowing the heat exchanging fluid out of the housing.

At 1402, the heat exchanging fluid at a second temperature is received at the main inlet of the reactor housing.

At 1404, the heat exchanging fluid at the second temperature is flowed from the main inlet of the reactor housing to the first and second catalyst reactors.

At 1406, the heat exchanging fluid at the second temperature is received at the first and second catalyst reactors.

At 1408, the heat exchanging fluid is flowed to at least a portion of the exterior surfaces of the first and second catalyst reactors such that the heat exchanging fluid transfers heat to the first fluid across the walls of the conduits.

At 1410, the first fluid is heated to a third temperature such that the first fluid changes its composition.

Thermally decomposing ammonia using a thermochemical recuperator can further include flowing the heat exchanging fluid to the main outlet and exhausting the heat exchanging fluid to an atmosphere.

In some embodiments, the first fluid includes ammonia. The first fluid can be heated to a temperature that changes its composition, for example, by decomposing the first fluid (e.g., ammonia) or portions thereof as heat is transferred from a heat exchanging fluid to the first fluid. In some embodiments, the method can include flowing the heat exchanging fluid to at least a portion of the exterior surfaces of the first and second catalyst reactors such that the heat exchanging fluid transfers heat to the first fluid across the walls of the conduits. The flowing of the heat exchanging fluid can induce turbulence to occur in the heat exchanging fluid as the heat exchanging fluid flows to at least the portion of the exterior surfaces of the first and second catalyst reactors to increase the transfer of heat from the heat exchanging fluid to the first fluid.

While a number of examples have been described for illustration purposes, the foregoing description is not intended to limit the scope of the invention, which is defined by the scope of the appended claims. There are and will be other examples and modifications within the scope of the following claims. Furthermore, one of skill in the art would appreciate that features described in reference to a specific embodiment are not limited to that embodiment and can be interchanged with features of other embodiments.

What is claimed is:

1. A catalyst reactor for decomposing ammonia, the reactor comprising:
an elongated conduit extending along a longitudinal axis, the elongated conduit comprising:
a wall defining an interior cavity, an inlet configured for receiving a first fluid, and an outlet to flow the first fluid out of the elongated conduit, the wall having an interior cross-section defined by a major axis, W, and a minor axis, H, the major axis and the minor axis defining an aspect ratio,
$$α = \frac{W}{H} ,$$
wherein the aspect ratio is greater than 2.0; and
a catalytic structure disposed within the interior cavity of the elongated conduit.

2. The catalyst reactor of claim 1, wherein the catalytic structure has a cross-section shape is the same shape as the interior cross-section of the elongated conduit.

3. The catalyst reactor of claim 1, wherein the catalytic structure comprises a plurality of catalytic structures, or a catalytic monolith.

4. The catalyst reactor of claim 1, wherein the catalytic structure is fixedly coupled to the elongated conduit by an interference fit.

5. The catalyst reactor of claim 1, wherein the catalytic structure comprises a metal foam substrate, or a plurality of catalyst pellets.

6. The catalyst reactor of claim 1, wherein the catalytic structure is disposed within the elongated conduit and configured to change a composition of the first fluid responsive to a transfer of heat across the wall of the elongated conduit.

7. The catalyst reactor of claim 1, wherein the elongated conduit comprises:
a first shell; and
a second shell configured to couple to the first shell;
wherein the first and second shells couple together to define the elongated conduit.

8. The catalyst reactor of claim 1, wherein the elongated conduit further comprises at least one stamped portion that recesses the wall in a transverse direction toward a central axis of the conduit wall.

9. The catalyst reactor of claim 8, wherein the at least one stamped portion comprises two opposing wall portions that are each recessed in a transverse direction toward a central axis of the conduit and coupled together.

10. A catalyst reactor system for decomposing ammonia, the system comprising:
a reactor housing defining an enclosure, the reactor housing including a main inlet configured for receiving a heat exchanging fluid and a main outlet for flowing the heat exchanging fluid out of the reactor housing;
a catalyst reactor assembly disposed within the enclosure of the reactor housing such that the heat exchanging fluid flows along an exterior of the catalyst reactor assembly, the catalyst reactor assembly comprising:
first and second catalyst reactors, each catalyst reactor comprising:
an elongated conduit comprising:
a wall defining an interior cavity and an exterior surface configured for transferring heat from the heat exchanging fluid to the interior cavity, an inlet configured for receiving a first fluid, an outlet configured to flow the first fluid out of the elongated conduit, the elongated conduit having an interior cross-section defined by a major dimension and a minor dimension, the major and minor dimensions defining an aspect ratio,
$$α = \frac{W}{H} ,$$
which has a value greater than 2.0; and
a catalytic structure disposed within the interior cavity of the elongated conduit;
an inlet conduit fluidically coupled to the inlets of the first and second catalyst reactors; and
an outlet conduit fluidically coupled to the outlets of the first and second catalyst reactors.

11. The catalyst reactor system of claim 10, wherein the inlet conduit further comprises an inlet flow control device configured to control the flow of the first fluid to the first and second catalyst reactors.

12. The catalyst reactor system of claim 10, wherein the outlet conduit further comprises an outlet flow control device configured to control the flow of the first fluid from the first and second catalyst reactors.

13. The catalyst reactor system of claim 10, wherein the elongated conduit is angled relative to the heat exchanging fluid to induce a turbulence in the heat exchanging fluid.

14. The catalyst reactor system of claim 10, further comprising a duct burner disposed in the reactor housing, the duct burner configured to:
mix a portion of the first fluid with the heat exchanging fluid to create a mixture, and
burn the mixture of the portion of the first fluid and the heat exchanging fluid to raise a temperature of the heat exchanging fluid.

15. The catalyst reactor system of claim 10, wherein the catalyst reactor assembly is positioned proximal to an output of a reduction catalyst reactor, or an oxidation catalyst reactor, of a power generation plant such that a threshold quantity of heat is transferred from the reduction catalyst reactor to the catalyst reactor assembly.

16. The catalyst reactor system of claim 10, wherein the catalytic structure is disposed within the elongated conduit and configured to change a composition of the first fluid responsive to a transfer of heat from the heat exchanging fluid across the wall of the elongated conduit.

17. A method for thermal decomposition, the method comprising:
receiving a first fluid at a first temperature from an inlet conduit at a catalyst reactor assembly, the catalyst reactor assembly comprising:
first and second catalyst reactors, each catalyst reactor comprising:
an elongated conduit comprising:
a wall defining an interior cavity and an exterior surface configured for transferring heat from the heat exchanging fluid to the interior cavity, an inlet configured for receiving a first fluid, an outlet configured to flow the first fluid out of the elongated conduit, the elongated conduit having an interior cross-section defined by a major dimension and a minor dimension, the major and minor dimensions defining an aspect ratio,
$$α = \frac{W}{H} ,$$
which has a value greater than 2.0, and
a catalytic structure disposed within the interior cavity of the elongated conduit,
the catalyst reactor assembly positioned within a reactor housing defining an enclosure, the reactor housing including a main inlet configured for receiving a heat exchanging fluid and a main outlet for flowing the heat exchanging fluid out of the enclosure;
receiving the heat exchanging fluid at a second temperature at the main inlet of the reactor housing;
flowing the heat exchanging fluid at the second temperature from the main inlet of the reactor housing to the first and second catalyst reactors;
receiving the heat exchanging fluid at the second temperature at the first and second catalyst reactors;
flowing the heat exchanging fluid to at least a portion of the exterior surfaces of the first and second catalyst reactors such that the heat exchanging fluid transfers heat to the first fluid across the walls of the conduits; and
heating the first fluid to a third temperature such that the first fluid changes its composition.

18. The method of claim 17, further comprising:
flowing the heat exchanging fluid to the main outlet; and
exhausting the heat exchanging fluid to an atmosphere.

19. The method of claim 17, wherein the first fluid comprises an ammonia, heating the first fluid to a third temperature such that the first fluid changes its composition comprises decomposing the ammonia responsive to the transfer of heat from the heat exchanging fluid to the first fluid.

20. The method of claim 17, wherein flowing the heat exchanging fluid to at least a portion of the exterior surfaces of the first and second catalyst reactors such that the heat exchanging fluid transfers heat to the first fluid across the walls of the conduits comprising inducing turbulence in the heat exchanging fluid as the heat exchanging fluid flows to at least the portion of the exterior surfaces of the first and second catalyst reactors to increases the transfer of heat from the heat exchanging fluid to the first fluid.
